(19) United States
(12) Patent Application Publication
(10) Pub. No.: US 2008/0238768 A1
(43) Pub. Date: Oct. 2, 2008

(54) GPS tracking & behavior monitoring device with back-end software program service integrations

(76) Inventor: Michael Albert Nosworthy, West Islip, NY (US)

Correspondence Address: Michael Albert Nosworthy, P.O. Box 252, West Islip, NY, 11795, US

(21) Appl. No.: 11/728,273

(22) Filed: Mar. 26, 2007

(51) Int. Cl. G01S 1/02

(52) U.S. Cl. 342/357.09; 116/67 R; 342/357.01; 342/357.13; 702/2; 705/32

(57) ABSTRACT

This patent is a high quality Global Position (GPS) product/service that focuses on the growing public and government interest in personal and asset safety. This is a portable transmitter GPS (wristwatch) called “Ambertrax™” to be monitored via satellite and specifically designed to be tracked over the internet with a receiver/transmitter (PDA) and a powerful satellite decoder super computer infrastructure that will also be able to host millions of simultaneous GPS singles.

In its' basic configuration, the Ambertrax™ wristwatch is a multifunction tracking and behavior-monitoring device, with a 911 panic button and will be linked to a central internet “observe and record” 24/7/365 monitoring station.

Furthermore, a proximity warning will activate an alert should preset parameters determine that the distance between the PDA and wristwatch is greater then programed or if a sexual offender wearing a GSP monitoring device comes within a certain pre programed distance within the wristwatch.

GPS devices & Services are common in todays world, but my claims below are unique in nature in the ways they have been assembled.

### TECHNICAL FIELD OF THE INVENTION

The present disclosure concerns an advanced electronic personal locating device for determining the location/position of a stationary or mobile object or individual. Specifically, it utilizes the capabilities of voice communication systems and satellite-based global positioning system (GPS) services.

### BACKGROUND

The Internet is a large network that interconnects millions of computers around the world and allows the transfer of data between any numbers of computer systems using the Transmission Protocol/Internet Protocol (TCP/IP). Computers that respond to service requests from other computers networked are known as servers while computers that initiate requests for service from a server are referred to as clients. The popularity of the Internet is due to the World Wide Web (WWW), a network of links to hypertext documents (Web documents, Web pages, or hypertext documents). Information about these Web documents is controlled and provided by servers. At the user's end, a Web client takes the user's requests and passes them on to the server. In order to access, process, and display a Web document, a client uses a set of instructions, referred to as a browser.

There a numerous fee-based Web sites that offer users navigation-like aids to locate a specific address (tourist attraction, restaurant, Movie Theater, etc.) and provide a map or a series of directions to the location in question. Although the Internet and the World Wide Web is able to assist in locating fixed sites, this technology cannot be employed to locate a mobile remote individual (or object or animal). In fact, precisely tracking such movement and location has been difficult. There are a few tracking systems that employ wireless communication capabilities; however, they are unreliable, bulky and expensive.

Now, with the advent of GPS services, it is possible to provide relatively inexpensive tracking of a moving object or individual. The GPS is a satellite-based navigation system developed by the US Department of Defense for military and government use. However, the information or valuable data derived is freely available to anyone.

GPS is a broadcasting system in which satellites transmit information towards where GPS receivers take the transmitted information to chart the precise location of the object or individual. In simple terms, the GPS receiver compares signal transmission time with the signal reception time, and then uses the time difference between the two along with the propagation speed to calculate the distance from each of the visible satellites.

Typically, the position of an object or individual is determined by coincident reception of signals from at least three GPS satellites by a satellite receiver, which position can then be stored or can be transmitted to a central receiving station via some sort of wireless link. This wireless link can be a two-way communication link wherein the positioning information is only transmitted in response to receiving a request. Some disadvantages of the GPS technology are: (i) relatively slow in acquiring location data; (ii) strength is strongly dependent upon the target object being in an open area where it is in a line of sight position relative to at least three GPS satellites; (iii) GPS receiver that must be included in a locating device requires the use of substantial electrical energy during the period in which the location information is being acquired and developed from the GPS system. Therefore, there is an immediate need in the GPS technology area for a small, easy to operate portable object / person locator, in addition to minimizing the use of electrical power while being subjected to less than ideal orientations to enable quick and efficient location by the GPS system.

### DETAILED DESCRIPTION OF THE INVENTION

In this specification, although the preferred embodiments have been described in detail, it should be understood that various changes, substitutions and alterations could be made therein without departing from the spirit and scope of the invention. Therefore, the specification is to be regarded in an illustrative rather than a restrictive sense.

Unless specifically stated otherwise, scientific and technical terms employed in this specification in connection with the present invention shall have the meanings that are commonly understood by one of ordinary skill in the art. Furthermore, unless otherwise required by context, singular terms shall include pluralities and plural terms shall include the singular. Generally, nomenclatures used in connection with, and standard techniques described herein are those well known and commonly used in the art. Although the methods and apparatus of the present invention have been described with reference to GPS satellites, it will be appreciated that the teachings are equally applicable to positioning systems which utilize pseudolites or a combination of satellites and pseudolites. For instance, the term “satellite”, as used herein, is intended to include pseudolite or equivalents thereof, and the term “GPS signals”, is intended to include GPS-like signals from pseudolites or equivalents thereof. It will be further appreciated that the methods and apparatus of the present invention are equally applicable for use with the GLONASS and other satellite-based positioning systems.

The device described in the instant disclosure comprises an apparatus and a method for locating or tracking an object or individual having attached thereto said device operable to acquire precise location information downloaded from a GPS system.

### The Device

The device will be completely self-contained and worn as a wristwatch, bracelet, etc. In fact, the device can be incorporated or molded into any form or format. The tracking device will preferably be in a watch format. It will incorporate a combination of “state-of-the-art” GPS locating technology and GSM/GPRS cellular technology during tracking. The device will be a multifunction tracking and behavior-monitoring device with a 911 panic button via the Internet and/or central operating station. The service could be Internet-based using GPS (global positioning service) technology to: track and monitor, co-ordinate an event, and/or observe behavioral patterns of humans, animals and/or objects.

In the event of an alarm activation to locate the person wearing the watch, all alerts and tracking will be reported via World Wide Web to a central monitoring facility, and dispatched accordingly. That facility will deliver a time-stamped report of the location of the person to wherever deemed by the customer to effectively find the person. If the device is a watch, it will display the time, the battery level, the GSM signal, and the GPS signal. In addition, it could also have four side buttons (two on each side) having “arm” and “disarm” features in addition to a “panic button” and telephone numbers pre-programmed into a SIM card (with up to 200 names and numbers contained therein) for voice communication when a wired/wireless headset is connected to the watch via porthole. The core technology behind the device will be a complete module with an integrated Tri Band GSM/GPRS core with a 12 parallel channel GPS receiver that features the SiRFstar II or III low power chipset consisting of high-performance GPS core including acquisition, accelerator, DGPS processor, multi-path mitigation hardware, proximity and satellite tracking engine.

The device is a major breakthrough and advancement in GPS personal tracking/voice communication and monitoring integration. The watch integrates a GPS and GSM antennas, power regulation and interface circuitry in a very compact form factor. The superior TTFF acquisition rate together with the low power consumption allows the creation of high-efficient tracking, security and monitoring solutions. The watch will have a small battery (700 mAH) as standard Li-ion Rechargeable battery pack lasting up to 72 hours. For military applications (solders in the field) it is recommended that there be a separation of the cell and GPS technology into two units that will give a few months life expectancy of battery power and even possibly up to a year depending upon design requirements and tracking cycles.

Furthermore the design of a GSM/GPRS/GPS Pocket PC PDA will be available as a means of mobile real-time tracking. This PDA device is programmable to be in synchronization specifically to track any number of wristwatches it is programmed to in full digital mapping.

Other objects, features, and advantages of the present invention will become apparent from the following detailed description. It should be understood, however, that the description, while indicating preferred embodiments of the present invention, are given by way of illustration only, since various changes and modifications within the spirit and scope of the invention will become apparent to those skilled in the art from the description.

### Housing

For the housing of the device (e.g., watch), a proprietary polymeric material(s) will be used. This polymeric material (TW polymer) is lightweight, flame-retardant, non-corrosive, non-conductive, and chemical-resistant. The polymer(s) will be resistant to any known solvent, acid, base, or chlorinating agents as well as low levels of radiation. Although the material is not conductive to electric current, it can be modified to be made conductive. Furthermore, the polymer material(s) used as housing will not interfere, distort, or cause loss of signal strength of GPS or cellular frequencies.

The polymeric material has passed military specification tests. It was tested at minus 700 degrees with no distortions or fragility and could not be penetrated or cut by acetylene torch at 4000 degrees. In the case of a wristwatch, if a plastic is used as the housing, it can be easily molded and manufactured by plastics processor with a minimum thickness of 1/32^{nd} of an inch. At 5/32^{nd} of an inch, this polymer is 11 times stronger than steel and 5 times lighter that steel.

### MODUAL USES FOR TRACKING

THE FOLLOWING: PEOPLE, PLACES, THINGS AND SITUATIONS WILL ALL BENEFIT BY HAVING THIS INVENTION ATTACHED TO OR USED FOR TRACKING PURPOSES AS DESCRIBED WITH BUT NOT LIMITED TO THIS Patents Claims
ADULTS
AGRICULTURAL FARMING VEHICLES
AIRFORCE
AIRPLANES
AERIAL MAPPING
AMBULANCE FLEETS
AMUSEMENT PARKS
ANIMAL SHOWS
ANIMALS
AQUATIC MAPPING
AREANAS
ARMORED CARS/TRUCKS
ARMY
AUTHORITY PEOPLE
AUTOMOBILE FLEETS
AUTOMOBILES
BALLOON TOURS
BASEBALL
BASEBALL ARENAS
BEACHES
BLIND PEOPLE
BOAT CRUISES
BOAT RENTALS
BOATS
BUSES
CAMPS
CAR RENTALS
CASINOS
CATS
CELL PHONES
CENTRAL INTELLIGENT AGENCY
CHILD CUSTODY
CHILDREN UNDER 18
CIRCUSES, CARNIVALS, FAIRS
COLISEUMS
COMPETITIONS (track progress)
CONSTRUCTION SITES
COURT ASSIGNED
CROP FARMING
DAY CARE CENTERS
DEPARTMENT OF CORRECTIONS
DEPARTMENT OF DEFENCE
DEPARTMENT OF HOMELAND SECURITY
DIVERS
DOGS
EMPLOYEES
FEDERAL BUREAU OF INVESTIGATIONS
FEDERAL EMERGENCY MANAGEMENT AGENCY/F.E.M.A.
FIRE FIGHTERS
FIRE TRUCKS
FOOTBALL
FOOTBALL ARENAS
FORSTER CARE FACILITIES
GAMES
GEOGRAPHICAL MAPPING
GOCART RACEWAY OPERATION
GOLF CARTS
GOLFERS
GOVERNMENT AGENCIES, FACILITIES, PEOPLE & PROCEDURES
HANDICAPPED PEOPLE
HOCKEY
HOCKEY ARENAS
HORSE RIDING TRAILS
HORSES
HOSPITAL DOCTORS, NURSES, EMPLOYEES, STAFF
HOSPITAL PATIENTS
HOSPITALS
HUNTERS proximity warning/avoid shooting each other
LAND SURVEY
LAPTOP COMPUTERS
LIFEGUARDS
MARATHONS sponsored by us: track loved ones progress along the way over the internet & show on TV
MARINES
MENTALLY DISABLED PEOPLE
MILITARY
MINING
MISSILES
MUSEUMS
NATIONAL OCEANIC ATMOSPHERIC ADMINISTRATION/N.O.A.A.
NATURE HIKES
NAVIGATION
NAVY
NURSING HOMES
OFFICE OF EMERGENCY MANAGEMENT/O.E.M.
OLYMPICS
PAINTBALL
PARACHUTERS
PARENTS
PARKS
PAROLEES
PDA'S
PEDIATRIC DR. OFFICE
PEDIFILIER
PETS
PICNIC GROUNDS
POLICE ACADEMIES
POLICE OFFICERS
POLITICAL PEOPLE
POLITICIANS
POOLS
PORT AUTHORITY
PORTS
PRISONERS
RAPISTS
RETIREMENT HOMES
S.W.A.T/SPECIAL WEAPONS AND TACTICS
SCHOOL BUSES
SCHOOLS sexual predator proximity alert
SCUBA DIVERS
SECRET SERVICE AGENCY
SENIORS
SERGORY
SEXUAL OFFENDERS
SHIPPING CARGO
SHIPPING PORTS
SHOPPING MALLS
SHUTTLE BUSES
SKI LODGES
SKIERS
SOCCER
SOLDIERS
SPACE MAPPING
SPORTING EVENTS
SPORTS
TAXI CABS
THEME PARKS
TOURIST GUIDES (proximity alerts to tour guide)
TOURS
TRAINING
TRAINS
TRANSIT AUTHORITY
TRANSIT AUTHORITY VEHICLES, BOATS, BUSES, TRAINS, TAXIS
TRI-ATHLONS
WAR
WHEELCHAIRS (detachable to-go)

### Consumer Benefits

The device will give parents a piece of mind, preserve individuals' well-being and give abducted or lost individuals a potential lifesaver device. Proprietary customers for this device are children, the elderly, and the handicapped.

Children may be monitored at the guardian's discretion while out with friends, in school, in camp, on visiting rights, on vacation, at a theme park, while swimming, etc. The elderly may be monitored while outside of nursing care, walking in the neighborhood, etc. Handicapped individuals may be monitored depending on their severity of disability. Clearly, there is a commercial need for this device as it is likely to reduce the high incidence of missing, murdered, lost, and abducted individuals in the Unites States.

This device will enable individuals to tap into a multi-billion dollar GPS system in a simple and cost effective manner. Since the device takes advance of the Internet, it has a global utility.

### GPS Receiver Module

### 1. Characteristics:

The GPS receiver module is based on “SiRF” Star III high-sensitivity chipset solution, which includes a build-in Sarantel Passive Geo-Helix SMP omni-directional antenna. It can track 20 satellites simultaneously, integrated GPS receiver update navigation data every second and provide your exact location information soon after the power is turned on.

The GPS receiver is designed for a broad spectrum of OEM personal positioning and navigation applications, such as hand-held or portable device. It will help you integrate to the system platform easily. It meets strict needs such as car navigation, mapping, surveying, security, agriculture and so on.

Some of the main features are as follows:
Build-in SiRF Star III chipset with standard SiRF GSW 3.0 software
Build-in Sarantel Passive Geo-helix SMP omni-directional antenna increases GSP signal receiving sensitivity
Twenty parallel satellites tracking channels for fast acquisition.
A-GPS ready
Compact size
Support NMEA0183 V. 3.01 data protocol.
Support 1PPS Output Signal Aligned with GPS timing
RS232 level serial port easily for system integration
Build-in back up power supply (Option)
   Some of the key benefits include:
Integrate GPS antenna and receiver
Filtering effect of the antenna gives high immunity to RF interface
High sensitivity GPS solution—Fast TTFF
Wide antenna Beam width
Low power consumption
Simple integration and acceleration for time-to-market

### 2. Specification

### 2.1. Absolute Maximum Rating

| Parameter | Min | Typ | Max | Units |
|---|---|---|---|---|
| Power Supply Voltage | 4.5 | 5.0 | 5.5 | V |
| Operating Current | 80 | 90 | 100 | mA |

### 2.2. Geohelix-SMP GPS Antenna Characteristics

| Parameter | Min | Typ | Max | Unit |
|---|---|---|---|---|
| Frequency | 1573.42 | 1575.42 | 1577.42 | MHz |
| Gain | −5.5 | −3.5 | | dBic |
| Beamwidth | | >120 | | Degrees |
| VSWR | | 2.0:1 | 2.3:1 | |
| Impedance | | 50 | | Ω |
| Operating | −40 | +20 | +85 | ° C. |
| Temperature Range | | | | |

### 2.3. GPS Technical Specification

| | ITEMS | DESCRIPTION |
|---|---|---|
| Chipset | GSP3F | SiRF Starill technology |
| General | Frequency | L1. 1575.42 MHZ |
| | C/A code | 1.023 MHz chip rate |
| | Channels | 20 |
| Accuracy | Position | 10 meters, 2D RMS |
| | | 5 meters 2D RMS, |
| | | WAAS corrected |
| | | <5 meters(50%), |
| | | DGPS corrected |
| | Velocity | 0.1 meters/second |
| | Time | 1 microsecond synchronized |
| | | to GPS time |
| Datum | Default | WGS-84 |
| | Other | selectable for other Datum |
| Time to First Fix | Reacquisition | 0.1 sec., average |
| (Open Sky & | Snap start | 1 sec., average |
| Stationary | Hot start | 8 sec., average typical TTFF |
| Requirements) | Warm start | 38 sec., average typical TTFF |
| | Cold start | 42 sec., average typical TTFF |
| Dynamic | Altitude | 18,000 meters (60,000 feet) |
| Conditions | | max. |
| | Velocity | 515 meters/second (1000 knots) |
| | | max. |
| | Acceleration | 4g. max. |
| | Jerk | 20 meters/second³, max. |
| Power | Main power input | 3.3 ± 10% V DC input. |
| | Power consumption | ≈230 mW (continuous mode) |
| | Supply Current | ≈70 mA |
| | Backup Power | 1.5 ± 10% V DC input. |
| Serial Port | Electrical interface | One full duplex serial TTL |
| | | interface. |
| | Protocol messages | NMEA-0183 @ 4800 bps |
| | | (Default) |
| Timemark-1PPS | Level | TTL |
| Pulse | Pulse duration | 100 ms |
| | Time reference | At the pulse positive edge. |
| | Measurements | Alligned to GPS second, ±1 |
| | | microsecond |

### 2.4. Backup Battery Conditions (Option)

| PARAMETER | Symbol | Min | Typ | Max | Units |
|---|---|---|---|---|---|
| RTC(Battery) Power | VSTBY | 1.4 | 1.5 | 1.6 | V |
| Supply Current | | | 10 | | μA |

### 2.5. Software Operation Condition

| ITEMS | DESCRIPTION | | |
|---|---|---|---|
| Core of firmware | SIRF GSW version 3.0 | | |
| Baud rate | 4800 (Default) | | |
| Code type | NMEA-01183 ASCII | | |
| Datum | WGS-84 | | |
| Protocol message | GGA(1 sec), GSA(5 sec), GSV(5 sec), | | |
| | RMC(1 sec). VTG(1 sec). | | |
| Output frequency | 1 Hz | | |
| Acquisition | Cold start | 28 | dB-Hz (−143 dBm) |
| Sensitivity | Warm start | 28 | dB-Hz |
| | Hot start | 15 | dB-Hz |
| | (Standard) | | |
| | Tracking | −159 | dB |

### 2.6. Communication Specification

| PARAMETER | SPECIFICATION |
|---|---|
| Interface | Simple UART |
| Bit rate | 4.800 bps |
| Start bit | 1 bit |
| Stop bit | 1 bit |
| Data bit | 8 bit |
| Parity | None |
| Transmission data | NMEA 0183 Ver 3.01 |

### 2.7. Environmental Characteristics

| ITEM | MINIMUN | MAXIMUM |
|---|---|---|
| Operation conditions | −40° C. | +85° C. |
| Storage conditions | −55° C. | +100° C. |

*Operation humidity: 5% to 90% No condensing.

### 2.8. Other Characteristics

| | ITEMS | DESCRIPTION |
|---|---|---|
| Physical | Length (with Antenna) | 59.5 mm (2.34 in) |
| Characteristics | Width | 26.4 mm (1.04 in) |
| | Weight | ~14 g(w/Battery): |
| | | ~13 g(w/o Battery) |
| Interface | #1 | Vcc (+5 V) |
| (Pin Assignment) | #2 | Back-up(+3.3 V) |
| | #3 | 1 PPS |
| | #4 | TX_RS232 (RS232 level) |
| | #5 | RX_RS232 (RS232 level) |
| | #6 | Ground |

### 2.9. NMEA Output Messages

| MESSAGES | DESCRIPTION |
|---|---|
| GGA | Global positioning system fixed data |
| GSA | GNSS DOP and active satellites |
| GSV | GNSS satellites in view |
| RMC | Recommended minimum specific GNSS data |
| VTG | Course over ground and ground speed |

### GGA—Global Positioning System Fixed Data

### SGPGGA, 161229.487,3723.2475,N, 12158.3416, W, 1.07, 1.0,9.0,M, . . . 0000*18

| Name | Example | Units | Description |
|---|---|---|---|
| Message ID | $GPGGA | | GGA protocol header |
| UTC Time | 1611229.487 | | hhmmss.sss |
| Latitude | 3723.2475 | | ddmm.mmmm |
| N/S Indicator | N | | N = north or S = south |
| Longitude | 12158.3416 | | dddmm.mmmm |
| E/W Indicator | W | | E = east or W = west |
| Position Fix | 1 | | See Note |
| Indicator | | | |
| Satellites Used | 07 | | Range 0 to 12 |
| HDOP | 1.0 | | Horizontal Dilution of Precision |
| MSL Altitude ¹ | 9.0 | meters | |
| Units | M | meters | |
| Geoid | | meters | |
| Separation ¹ | | | |
| Units | M | meters | |
| Age of Diff. | | second | Null fields when DGPS is |
| Corr. | | | not used |
| Diff. Ref. | 0000 | | |
| Station ID | | | |
| Checksum | *18 | | |
| <CR> <LF> | | | End of message termination |

¹Values are WGS84 ellipsoid heights.
Note: Position Fix Indicator

| | |
|---|---|
| Value | Description |
| 0 | Fix not available or invalid |
| 1 | GPS SPS Mode, fix valid |
| 2 | Differential GPS, SPS Mode, fix valid |
| 3 | GPS PPS Mode, fix valid |

### GSA—GNSS DOP and Active Satellites

### SGPGSA,A,3.07,02,26,2,09,04, 15, . . . , 1.8, 1.0, 1.5×33

| Name | Example | Units | Description |
|---|---|---|---|
| Message ID | $GPGSA | | GSA protocol header |
| Mode 1 | A | | See Note 1 |
| Mode 2 | 3 | | See Note 2 |
| Satellite Used ¹ | 07 | | Sv on Channel 1 |
| Satellite Used ¹ | 02 | | Sv on Channel 2 |
| . . . | | | |
| Satellite Used | | | Sv on Channel 12 |
| PDOP | 1.8 | | Position Dilution of Precision |
| HDOP | 1.0 | | Horizontal Dilution of Precision |
| VDOP | 1.5 | | Vertical Dilution of Precision |
| Checksum | *33 | | |
| <CR> <LF> | | | End of message termination |

¹Satellite used in solution
Note 2

| | |
|---|---|
| Value | Description |
| 1 | Fix Not Available |
| 2 | 2D |
| 3 | 3D |

### GSV—GNSS Satellites in View

### SGPGSV.2.1.07.07.79.048.42.02.51.062.43.26.36.256.42,27.27.138.42*71

### SGPGSV.2.2.07.09.23.313.42.04.19.159.41.15.12.041.42*41

| Name | Example | Units | Description |
|---|---|---|---|
| Message ID | $GPGSV | | GSV protocol header |
| Number of | 2 | | Range 1 to 3 |
| Messages ¹ | | | |
| Message | 1 | | Range 1 to 3 |
| Number ¹ | | | |
| Satellites | 07 | | |
| in View | | | |
| Satellite ID | 07 | | Channel 1 (Range 1 to 32) |
| Elevation | 79 | degrees | Channel 1 (Maximum 90) |
| Azimuth | 048 | degrees | Channel 1 (True, Range 0 to 359) |
| SNR (C/NO) | 42 | dBHz | Range 0 to 99, null when not tracking |
| . . . | | | |
| Satellite ID | 27 | | Channel 4 (Range 1 to 32) |
| Elevation | 27 | degrees | Channel 4 (Maximum 90) |
| Azimuth | 138 | degrees | Channel 4 (True. Range 0 to 359) |
| SNR (C/No) | 42 | dBHz | Range 0 to 99, null when not tracking |
| Checksum | *71 | | |
| <CR> <LF> | | | End of message termination |

¹Depending on the number of satellites tracked multiple messages of GSV data may be required.

### RMC—Recommended Minimum Specific GNSS Data

### SGPRMc, 161229.487.A.3723.2475.N.12158.34 16.W.0.13.309.62.120598 . . . *10

| Name | Example | Units | Description |
|---|---|---|---|
| Message ID | $GPRMC | | RMC protocol header |
| UTC Time | 161229.487 | | hhmmss.sss |
| Status | A | | A = data valid or V = |
| | | | data not valid |
| Latitude | 3723.2475 | | ddmm.mmmm |
| N/S Indicator | N | | N = north or S = south |
| Longitude | 12158.3416 | | dddmm.mmmm |
| E/W Indicator | W | | E = east or W = west |
| Speed Over Ground | 0.13 | knots | |
| Course Over Ground | 309.62 | degrees | True |
| Date | 120598 | | Ddmmyy |
| Magnetic Variation¹ | | degrees | E = east or W = west |
| Checksum * 10 | | | |
| <CR> <LF> | | | End of message |
| | | | termination |

¹All “course over ground” data are geodetic WGS84 directions.

### VTG—Course Over Ground and Ground Speed

### SGPVTG309.62,T,MO0.13,N,0.2,K*6E

| Name | Example | Units | Description |
|---|---|---|---|
| Message ID | SGPVTG | | VTG protocol header |
| Course | 309.82 | degrees | Measured heading |
| Reference | T | | True |
| Course | | degrees | Measured heading |
| Reference | M | | Magnetic ¹ |
| Speed | 0.13 | knots | Measured horizontal speed |
| Units | N | knots | |
| Speed | 0.2 | km/hr | Measured horizontal speed |
| Units | K | | Kilometers per hour |
| Checksum | *6E | | |
| <CR> <LF> | | | End of message termination |

¹All “course over ground” data are geodetic WGS84 directions.

Wafer connector female (6 pin 1.0 mm pitch)

| Pin | Signal and Description |
|---|---|
| 1 | Vcc (+5 V) |
| 2 | Battery |
| 3 | 1 PPS |
| 4 | TX_RS232 (RS232 level) |
| 5 | RX_RS232 (RS232 level) |
| 6 | Ground |

What is claim:

1. The locations of claim 2 will be transmitted from the module worn on the body of a person/animal or carried within pockets of clothes or object(s) being transported and determine its' location.

2. The locations of claim 1 will transmit wireless singles into space from the modules GPS & cellular chipset where multiple GPS satellites will receive these singles and give the locations in terms of: longitude, latitude, altitude co-ordinates, and speed figures as to where the singles are originating from on earth, within earth or within earths' atmospheres.

3. The singles of claim 2 will be transmitted to a ground base facility where our back-end infrastructure computers will decode these singles and layer them as objects onto computer screens to be deciphered.

4. The objects from claim 3 will be displayed on a computer screen as a certain shape, size and color according to the user's preferences and layered onto a street map with proximity status of other objects and the module doing the mobile tracking.

5. The mobile tracking in claim 4 will be running off of a computer program that will determine the direction, speed and elevation of the module being tracked and also be able to encompass a layering not only of streets, but also of 3 dimensional aerial grid patterns not limited to one flat plane tracking.

6. The aerial grid patterns in claim 5 will encompass the layering of 3 dimensional grids that track the module with all fields surrounding the earths' inner and outer zones within permissible abilities such as but not limited to these areas encompassing the entire circumference surrounding the earth up to the physical points touching the GPS satellites in space, through the crust of the earth, and it's inner cores without limitation throughout.

7. The location terms of claim 2 will also be able to be affixed to but not limited to: vehicles, boats, planes, trains, fixed locations in, on and above the earth, buildings, plants, waterways patterns, war missiles. These location terms will be ascertained by means of, GPS, AGPS, DGPS, WAAS, Ultra Wide-Band, WIFI, Cellular triangulation, Pinging & Bluetooth Locations.

8. The location means of claim 7 can be integrated into the chipset of sensors as a symbiotic relationship to accomplish tasks. Such tasks would be but not limited to sensors placed on the ground to evaluate weather conditions and take barometric measurements, humidity, dew points, rainfall, sunlight, elevation shifts. Locations could then be pointed out according to the request of the users preferences for example the 10 highest rainfall areas, or the 10 lowest dew point areas, and so on as above.

9. The location terms ascertained by the means of in claim 7 will switch automatically (calculated by the module itself) between these means best fitted for its' environment, weather it is indoors, outdoors, underground, on water, in water, in space or in the air.

10. The proximity warning status of claim 4 will be accompanied during an alert or panic button activation by two types of audio beeps: one will be able to be heard by humans and the second beep will be layered within that audio single other frequencies that only an animal like a dog can hear and track its' location.

11. Audible singles in claim 10 can be manually set off by the user wearing or carrying the module or remotely over the internet.

12. The location terms of claim 2 will enhance the training of solders, field games, athletes and/or competitive animal sports which will enhance their desired outcomes from studying the database history of the results tracked.

13. The databases compiled in claim 12 while tracking the module can also extend over long periods of time such as month, years, decades and centuries to compile data for history changing analysis.

14. The location terms of claim 2 may be used within a symbiotic relationship of chipsets designed to produce automation results such as those attached to large farming machinery over the internet robotically to control such machines operations virtually or with automation.

15. The location terms of claim 2 may be used with the module by employers to track employees punching in and out for work as timestamps.

16. The computer displays of claim 3 will incorporate software that the module is linked to that decodes it's singles and gives locations to its whereabouts is capable of simultaneously decoding millions of singles at one time from the modules by what is deemed in technical terms, “hand shaking” that will enable this process to begin.

17. The locating methods of claim No. 1 proximity warnings will be a precursor barrier between sex offenders wearing a GPS device and a person wearing the module. This warning emitted by modules is a safeguard between vulnerable people and parolees required as part of their probation conditions required to wear a GPS device.
